(19) United States
(12) Patent Application Publication
(10) Pub. No.: US 2021/0349357 A1
(43) Pub. Date: Nov. 11, 2021

(54) DISPLAY PANEL AND DISPLAY DEVICE

(71) Applicant: TCL CHINA STAR OPTOELECTRONICS TECHNOLOGY CO., LTD, Shenzhen, Guangdong (CN)

(72) Inventor: Xingwu CHEN, Shenzhen, Guangdong (CN)

(21) Appl. No.: 17/042,987

(22) PCT Filed: May 20, 2020
(86) PCT No.: PCT/CN2020/091187

§ 371 Date: Sep. 29, 2020

(30) Foreign Application Priority Data
May 9, 2020 (CN) 202010385727.1

(51) Int. Cl. G02F 1/1343; G02F 1/1335

(52) U.S. Cl. CPC G02F 1/134309; G02F 2202/06; G02F 1/133538

(57) ABSTRACT

The present disclosure provides a display panel and a display device. The display panel includes a first electrode. An opening is defined at a side of the first electrode to improve problem that dark lines are prone to appear at a peripheral area of the first electrode of the display panel. The display device manufactured by using the display panel can improve transmittance and contrast of the display device, thereby improving display effect of the display device.

### FIELD OF INVENTION

The present disclosure relates to the field of display technologies, and particularly relates to a display panel and a display device.

### BACKGROUND OF INVENTION

An ultraviolet irradiation process needs to be additionally added in a liquid crystal cell process of polymer stabilized vertical alignment (PSVA) liquid crystal display mode, so that after liquid crystal molecules fall back in a certain direction, polymerizable monomers in liquid crystals polymerize to form a certain pretilt angle. However, in conventional pixel design framework, dark lines are prone to appear around pixels, and the dark lines will reduce a penetration rate of display devices, which will affect contrast and display effect of the display device.

### Technical Problems

Embodiments of the present disclosure provide a display panel and a display device, which can relieve the problem of dark lines and increase a penetration rate of the display device.

### Technical Solutions

Embodiments of the present disclosure provide a display panel, including:

a first electrode, and wherein an opening is defined at a side of the first electrode.

In the display panel, the first electrode comprises a main electrode and a plurality of branch electrodes, the main electrode defines a plurality of domain areas, the branch electrodes are disposed in the domain areas and electrically connect with the main electrode; the branch electrodes in at least one of the domain areas are provided with the opening.

In the display panel, the main electrode comprises a first trunk and a second trunk, and the first trunk and the second trunk are crossed; the domain areas comprise a first domain area and a second domain area adjacent to the first domain area; each of the branch electrodes disposed in the first domain area has a first angle with the first trunk, and each of the branch electrodes disposed in the second domain area has a second angle with the first trunk.

In the display panel, a value range of the first angle is greater than or equal to 0° and less than or equal to 30°; alternatively,

the value range of the first angle is greater than or equal to 60° and less than or equal to 90°.

In the display panel, a value range of the second angle is greater than or equal to 0° and less than or equal to 30°; alternatively,

the value range of the second angle is greater than or equal to 60° and less than or equal to 90°.

In the display panel, the first angle is greater than the second angle, and the branch electrodes disposed in the first domain area are provided with the opening at a side parallel to the second trunk.

In the display panel, the branch electrodes disposed in the second domain area are provided with the opening at a side parallel to the first trunk.

In the display panel, the domain areas further include a third domain area and a fourth domain area, the third domain area is opposite to the first domain area, and the fourth domain area is adjacent to the first domain area and the third domain area; each of the branch electrodes disposed in the third domain area has a third angle with the first trunk, and each of the branch electrodes disposed in the fourth domain area has a fourth angle with the first trunk.

In the display panel, the third angle is equal to the first angle, and the fourth angle is equal to the second angle.

In the display panel, the third angle is greater than the fourth angle, and the branch electrodes disposed in the third domain area are provided with the opening at a side parallel to the second trunk.

In the display panel, the branch electrodes disposed in the fourth domain area are provided with the opening at a side parallel to the first trunk.

In the display panel, the display panel is a liquid crystal display panel, and the display panel further includes:

a first substrate, wherein the first electrode is disposed on a side of the first substrate;

a second substrate disposed opposite to the first substrate, wherein the second substrate maintains a first distance from the first substrate; and

liquid crystal molecules disposed between the first substrate and the second substrate, wherein a chiral reagent is doped in the liquid crystal molecules, and a pitch of the liquid crystal molecules is equal to 2 to 15 times the first distance.

In the display panel, the first distance is greater than or equal to 2 μm and less than or equal to 4 μm.

In the display panel, the liquid crystal molecules are negative liquid crystal molecules, and an optical path difference of the liquid crystal molecules is greater than or equal to 300 nm and less than or equal to 550 nm.

In the display panel, the chiral reagent is a dextral chiral reagent, the first angle is greater than or equal to 60° and less than or equal to 90°, and the second angle is greater than or equal to 0° and less than or equal to 30°.

In the display panel, the chiral reagent is a levorotatory chiral reagent, the first angle is greater than or equal to 0° and less than or equal to 30°, and the second angle is greater than or equal to 60° and less than or equal to 90°.

In the display panel, the display panel further includes:

a first polarizer disposed on a side of the first substrate away from the second substrate; and

a second polarizer disposed on a side of the second substrate away from the first substrate; and

wherein a polarizing axis of the first polarizer coincides with the first trunk, and a polarizing axis of the second polarizer coincides with the second trunk.

The present disclosure further provides a display device including a display panel, the display panel includes:

a first electrode, and wherein an opening is defined at a side of the first electrode.

In the display device, the first electrode comprises a main electrode and a plurality of branch electrodes, the main electrode defines a plurality of domain areas, the branch electrodes are disposed in the domain areas and electrically connect with the main electrode; the branch electrodes in at least one of the domain areas are provided with the opening.

In the display device, the main electrode comprises a first trunk and a second trunk, and the first trunk and the second trunk are crossed; the domain areas comprise a first domain area and a second domain area adjacent to the first domain area; each of the branch electrodes disposed in the first domain area has a first angle with the first trunk, and each of the branch electrodes disposed in the second domain area has a second anile with the first trunk.

### Beneficial Effects

Compared with prior art, in the display panel and the display device provided by embodiments of the present disclosure, the display panel includes a first electrode. An opening is defined at a side of the first electrode to improve problem that dark lines are prone to appear at a peripheral area of the first electrode of the display panel. The display device manufactured by using the display panel can improve transmittance and contrast of the display device, thereby improving display effect of the display device.

### DESCRIPTION OF DRAWINGS

FIG. 1 is a schematic view of a display panel provided by an embodiment of the present disclosure.

FIGS. 2A-2G are schematic views of first electrodes provided by embodiments of the present disclosure.

### DETAILED DESCRIPTION OF EMBODIMENTS

In order to make purposes, technical solutions and effects of the present disclosure clearer, the present disclosure will be described in further detail below with reference to accompanying drawings in the embodiments. It should be understood that specific embodiments described herein are merely used to explain the present disclosure and are not intended to limit the present disclosure.

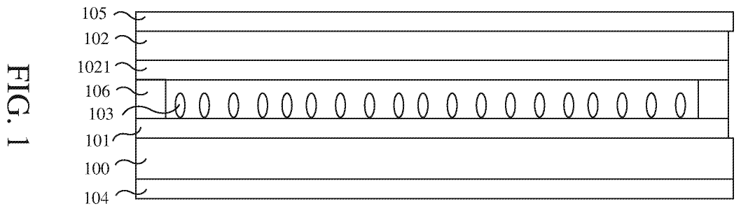

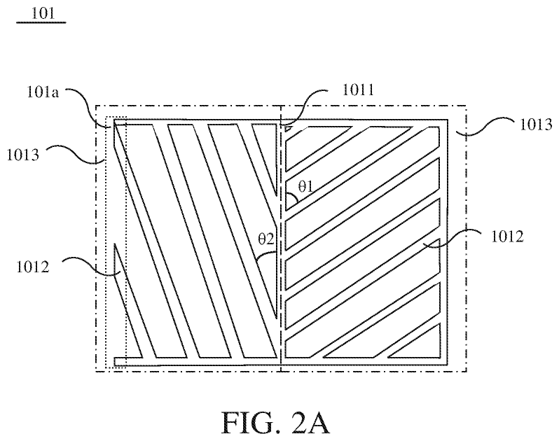

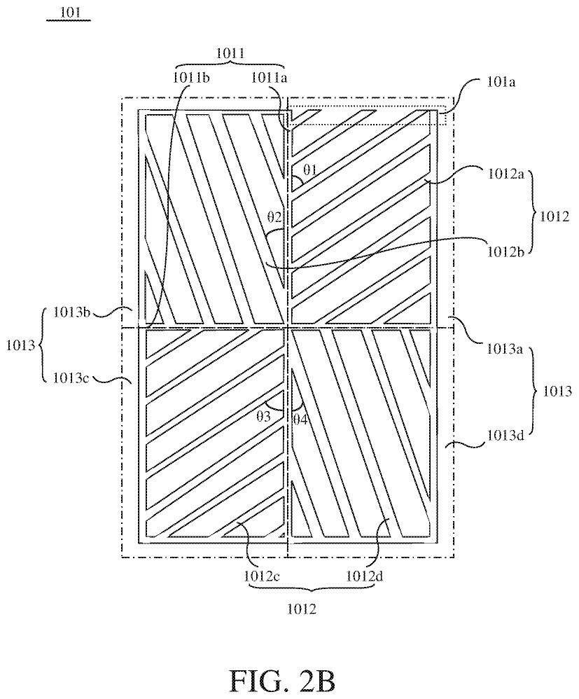

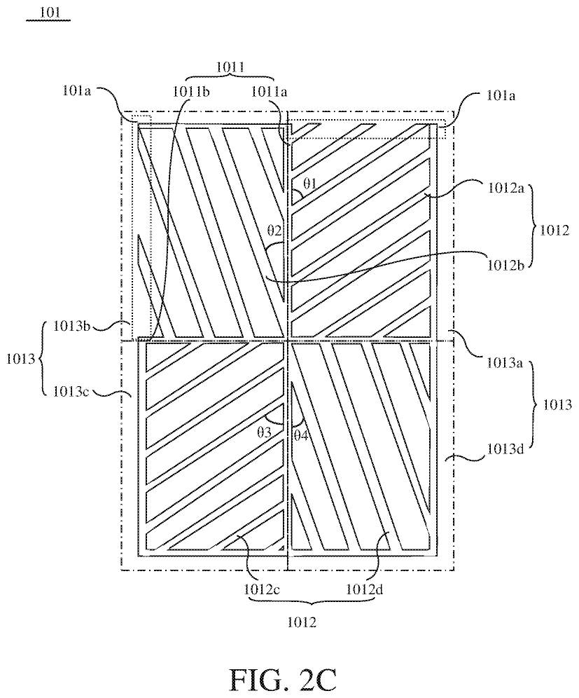

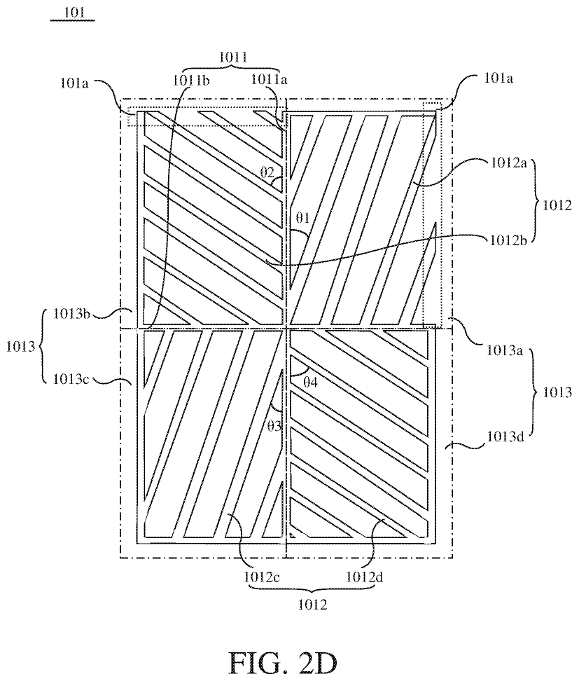

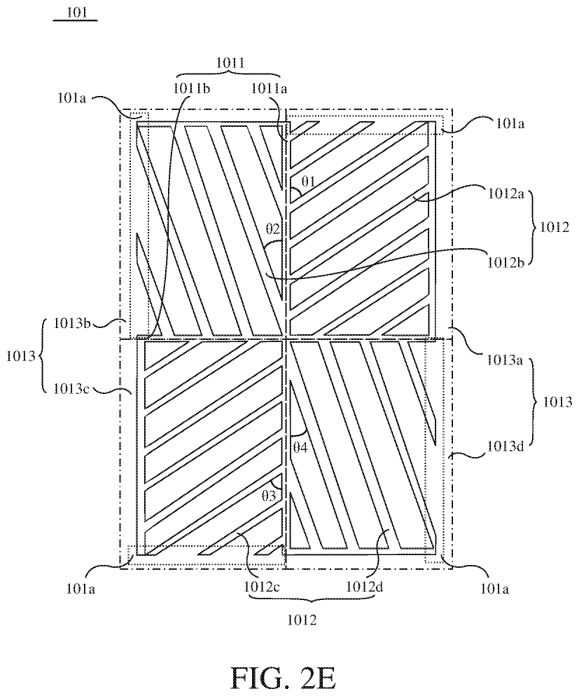

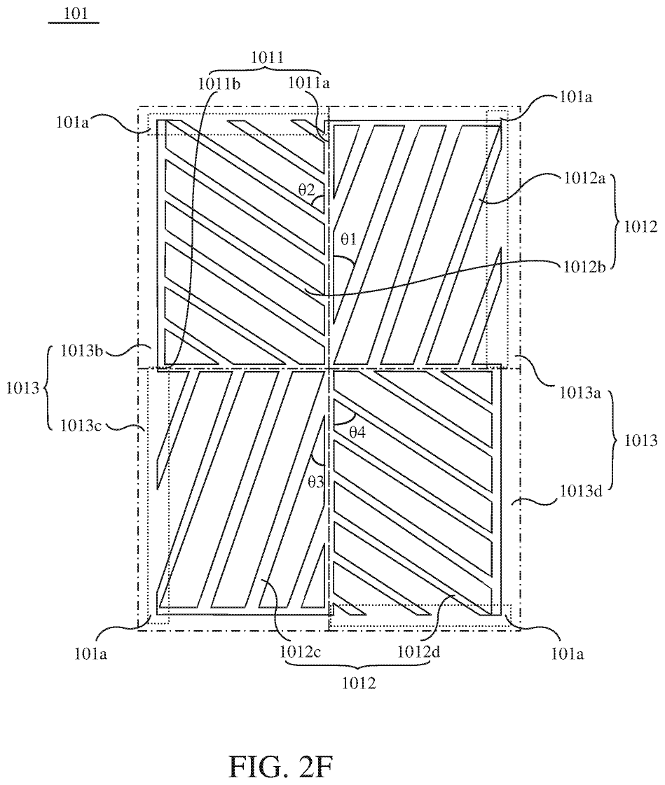

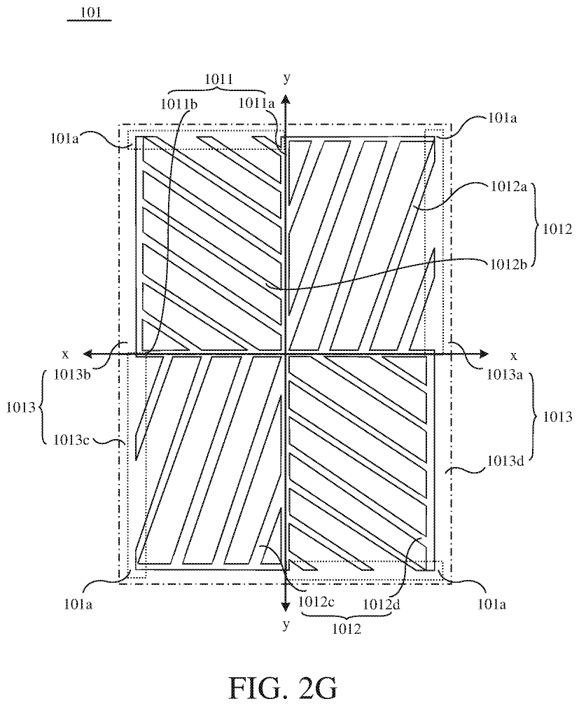

Specifically, referring to FIG. 1, it is a schematic view of a display panel provided by an embodiment of the present disclosure. As shown in FIGS. 2A-2G, they are schematic views of first electrodes provided by embodiments of the present disclosure.

The display panel includes a first electrode 101. An opening 101a is defined at a side of the first electrode 101 to improve problem that dark lines are prone to appear at a peripheral area of the first electrode 101 of the display panel and improve transmittance of the display panel.

Specifically, referring to FIGS. 2A-2G, the first electrode 101 includes a main electrode 1011 and a plurality of branch electrodes 1012. The main electrode 1011 defines a plurality of domain areas 1013. The plurality of branch electrodes 1012 are disposed in the plurality of the domain areas 1013 and connect with the main electrode 1011. The branch electrodes 1012 in at least one of the domain areas 1013 are provided with the opening 101a to relieve the problem of dark lines of the display panel and improve transmittance and contrast of the display device, thereby improving display effect of the display device.

In conventional display panels, the branch electrodes 1012 in the domain areas 1013 are closed. Affected by manufacturing process, the smaller the inclined angle of the branch electrode 1012 at a boundary of the domain area 1013, the higher the precision of preparation, and the more difficult it is to accurately restore the design angle during actual preparation, thereby resulting in irregular areas. The irregular areas will form dark lines during displaying, thereby affecting display effect of the display panel. Therefore, in the present disclosure, an opening 101a are defined at a side of the first electrode 101, or the branch electrodes 1012 in at least one of the domain areas 1013 are provided with the opening 101a, so that preparation difficulty of the first electrode 101 is reduced, and the first electrode 101 is also easier to meet design requirements. Thus, the display panel can relieve the problem of dark lines and improve display effect.

Furthermore, the main electrode 1011 includes a first trunk 1011a and a second trunk 1011b crossed with the first trunk 1011a. The domain area 1013 includes a first domain area 1013a and a second domain area 1013b adjacent to the first domain area 1013a. Each of the branch electrodes 1012a disposed in the first domain area 1013a has a first angle θ1 with the first trunk 1011a, and each of the branch electrodes 1012b disposed in the second domain area 1013b has a second angle θ2 with the first trunk 1011a, as shown in FIG. 29.

Furthermore, if the first angle θ1 is greater than the second angle θ2, the branch electrodes 1012a in the first domain area 1013a are provided with the opening 101a at a side parallel to the second trunk 1011b, as shown in FIG. 2B.

Furthermore, the branch electrodes 1012b in the second domain area 1013b are provided with the opening 101a at a side parallel to the first trunk 1011a, as shown in FIG. 2C.

Similarly, if the first angle θ1 is less than the second angle θ2, the branch electrodes 1012a in the first domain area 1013a are provided with the opening 101a at a side parallel to the first trunk 1011a.

Furthermore, the branch electrodes 1012b in the second domain area 1013b are provided with the opening 101a at a side parallel to the second trunk 1011b, as shown in FIG. 2D.

Whether the branch electrodes 1012 disposed in different domain areas 1013 are provided with the opening 101a is determined according to the inclined angles of the branch electrodes 1012 disposed in different domain areas 1013 relative to the first trunk 1011a, thereby relieving the problem that the conventional display panel is affected by process accuracy, and etching accuracy cannot be achieved in a small angle area around the first electrode 101, so dark lines are prone to appear in the display panel.

A value range of the first angle θ1 is greater than or equal to 0° and less than or equal to 30°; alternatively; the value range of the first angle θ1 is greater than or equal to 60° and less than or equal to 90°. Similarly, a value range of the second angle θ2 is greater than or equal to 0° and less than or equal to 30°; alternatively, the value range of the second angle θ2 is greater than or equal to 60° and less than or equal to 90°.

Furthermore, referring to FIGS. 2B-2G, the domain areas 1013 further include a third domain area 1013c opposite to the first domain area 1013a and a fourth domain area 1013d. The fourth domain area 1013d is adjacent to the first domain area 1013a and the third domain area 1013c, each of the branch electrodes 1012c disposed in the third domain area 1013c has a third angle θ3 with the first trunk 1011a, and each of the branch electrodes 1012d disposed in the fourth domain area 1013d has a fourth angle θ4 with the first trunk 1011a.

Wherein, the third angle θ3 may be equal to the first angle θ1, and the fourth angle θ4 may be equal to the second angle θ2.

Additionally, if the third angle θ3 is greater than the fourth angle θ4, the branch electrodes 1012c disposed in the third domain area 1013c are provided with the opening 101a at a side parallel to the second trunk 1011b.

Furthermore, the branch electrodes 1012d disposed in the fourth domain area 1013d are provided with the opening 101a at a side parallel to the first trunk 1011a, as shown in FIG. 2E.

If the third angle θ3 is less than the fourth angle θ4, the branch electrodes 1012c disposed in the third domain area 1013c are provided with the opening 101a at a side parallel to the first trunk 1011a.

Furthermore, the branch electrodes 1012d disposed in the fourth domain area 1013d are provided with the opening 101a at a side parallel to the second trunk 1011b, as shown in FIG. 2F.

The first electrode 101 is a pixel electrode. The display panel may be a liquid crystal display panel. Specifically, referring to FIG. 1, if the display panel is a liquid crystal display panel, the display panel further includes:

a first substrate 100, wherein the first electrode 100 is disposed on a side of the first substrate 100;

a second substrate 102 disposed opposite to the first substrate 100, wherein the second substrate 102 maintains a first distance d from the first substrate 100; and,

liquid crystal molecules 103 disposed between the first substrate 100 and the second substrate 102.

Furthermore, a chiral reagent is doped in the liquid crystal molecules 103, so that a pitch p of the liquid crystal molecules is equal to 2 to 15 times the first distance d.

Specifically, the first distance d is greater than or equal to 2 μm and less than or equal to 4 μm.

The liquid crystal molecules 103 are negative liquid crystal molecules, an optical path difference And of the liquid crystal molecules 103 is greater than or equal to 300 nm and less than or equal to 550 nm, thereby improving transmittance per unit area of the display panel. The pitch p of the liquid crystal molecules 103 is greater than or equal to 4 μin and less than or equal to 60 μm.

A helical twisting force generated by the chiral reagent drives the liquid crystal molecules 103 in periphery to periodically rotate, which reduces dark line area and improves dark line phenomenon of the display panel, which is beneficial for increasing the transmittance of the display panel. On the basis of providing the opening 101a at a side of the first electrode 101 of the display panel, the transmittance of the display panel can be further improved by doping the chiral reagent in the liquid crystal molecules 103.

In order to further increase the transmittance of the display panel on the basis of providing the opening 101a at a side of the first electrode 101 and doping the chiral reagent into the liquid crystal molecules 103, the first angle θ1 and the second angle θ2 are also slightly different according to differences of the chiral reagent and the pitch p. Specifically, As shown in a table below, it a table of value ranges of the first angle θ1 and the second angle θ2 when different chiral reagents are used or the pitch p takes different values.

| | Chiral reagent | | | |
|---|---|---|---|---|
| | Dextral | | Levorotatory | |
| | first angle | second angle | first angle | second angle |
| Pitch (p) | (θ1) | (θ2) | (θ1) | (θ2) |
| p ≤ 11 | 75° ≤ θ1 ≤ 90° | 0° ≤ θ2 ≤ 15° | 0° ≤ θ1 ≤ 15° | 75° ≤ θ2 ≤ 90° |
| 11 ≤ p ≤ 13.5 | 75° ≤ θ1 ≤ 90° | 0° ≤ θ2 ≤ 15° | 0° ≤ θ1 ≤ 15° | 75° ≤ θ2 ≤ 90° |
| 13.5 ≤ p ≤ 16 | 70° ≤ θ1 ≤ 90° | 0° ≤ θ2 ≤ 20° | 0° ≤ θ1 ≤ 20° | 70° ≤ θ2 ≤ 90° |
| 16 ≤ p ≤ 18.5 | 65° ≤ θ1 ≤ 90° | 5° ≤ θ2 ≤ 25° | 5° ≤ θ1 ≤ 25° | 65° ≤ θ2 ≤ 90° |
| 18.5 ≤ p | 60° ≤ θ1 ≤ 90° | 10° ≤ θ2 ≤ 30° | 10° ≤ θ1 ≤ 30° | 60° ≤ θ2 ≤ 90° |

If the chiral reagent is a dextral chiral reagent, the first angle θ1 is greater than or equal to 60° and less than or equal to 90°, the second angle θ2 is greater than or equal to 0° and less than or equal to 30°; and if the chiral reagent is a levorotatory chiral reagent, the first angle θ1 is greater than or equal to 0° and less than or equal to 30°, the second angle θ2 is greater than or equal to 60° and less than or equal to 90°. The chiral reagent includes S811, S1011, 8811, and CB15 etc, thereby maximizing the transmittance of the display panel.

Furthermore, the second substrate 102 further includes a second electrode 1021, and the display panel further includes sealant 106 disposed between the first electrode 101 and the second electrode 1021. The liquid crystal molecules 103 are disposed between the first electrode 101 and the second electrode 1021 and are disposed in an area defined by the sealant 106. The second electrode 1021 is a common electrode.

Furthermore, the display panel further includes portions that are not shown, such as a color filter film, a black matrix, and spacers etc., to enable the display panel to achieve color display and prevent the display panel from leaking light.

In order to arrange the liquid crystal molecules 103 in a specific direction, the first substrate 100 further includes a first alignment layer, and the second substrate 102 further includes a second alignment layer. The liquid crystal molecules 103 are disposed between the first alignment layer and the second alignment layer. The liquid crystal molecules 103 are injected between the first substrate 100 and the second substrate 102 by inkjet printing. After the first substrate 100 and the second substrate 102 are bonded to form a liquid crystal cell, the liquid crystal cell is treated by a PSVA process, so that the liquid crystal molecules 103 form pretilt angles, thereby obtaining the display panel. Wherein, the PSVA process refers to irradiating the liquid crystal cell with ultraviolet light under power-on conditions, so that the liquid crystal molecules 103 are reversed in a certain direction, and the polymerizable monomers in the liquid crystal molecules 103 are polymerized with ultraviolet light irradiation, thereby forming certain pretilt angles.

Referring to FIG. 1 and FIG. 2G, the display panel further includes:

a first polarizer 104 disposed on a side of the first substrate 100 away from the second substrate 102; and

a second polarizer 105 disposed on a side of the second substrate 102 away from the first substrate 100; and

wherein a polarizing axis x of the first polarizer 104 coincides with the first trunk 1011a, and a polarizing axis y of the second polarizer 105 coincides with the second trunk 1011b, as shown in FIG. 2G, so that a width of the area where dark lines appear in the first electrode 101 is reduced, aperture ratio of the display panel is increased, and the transmittance of the display panel is maximized.

Additionally, in FIGS. 2A to 2G, the first trunk 1011a and the second trunk 1011b are arranged orthogonally. It is conceivable that in other embodiments, the first trunk 1011a and the second trunk 1011b may also be set to other angles, which is not repeated herein.

The present disclosure further provides a display device including the display panel.

In the display panel and the display device provided by embodiments of the present disclosure, the display panel includes a first electrode 101. An opening 101a is defined at a side of the first electrode 101 to improve problem that dark lines are prone to appear at a peripheral area of the first electrode 101 of the display panel. The display device manufactured by using the display panel can improve transmittance and contrast of the display device, thereby improving display effect of the display device.

In the above embodiments, the description of each embodiment has its own focus. For the parts that are not detailed in an embodiment, please refer to the related descriptions in other embodiments.

The display panel and display device provided in the embodiments of the present disclosure have been described in detail above, and specific examples have been used to explain principles and implementations of the present disclosure. The descriptions of the above embodiments are merely used to help understand the technical solution of the present disclosure and its core ideas; it will be understood by those of ordinary skill in the art that the technical solutions described in the foregoing embodiments may be modified or equivalently substituted for some or all of the technical features, and the modifications or substitutions do not depart from the scope of the technical solutions of the embodiments of the present disclosure,

What is claimed is:

1. A display panel, comprising:
a first electrode;
wherein an opening is defined at a side of the first electrode.

2. The display panel in claim 1, wherein the first electrode comprises a main electrode and a plurality of branch electrodes, the main electrode defines a plurality of domain areas, the plurality of branch electrodes are disposed in the plurality of domain areas and electrically connect with the main electrode, and the branch electrodes in at least one of the domain areas are provided with the opening.

3. The display panel in claim 2, wherein the main electrode comprises a first trunk and a second trunk, the first trunk and the second trunk are crossed, the domain areas comprise a first domain area and a second domain area adjacent to the first domain area, each of the branch electrodes disposed in the first domain area has a first angle with the first trunk, and each of the branch electrodes disposed in the second domain area has a second angle with the first trunk.

4. The display panel in claim 3, wherein a value range of the first angle is greater than or equal to 0° and less than or equal to 30°; alternatively,
the value range of the first angle is greater than or equal to 60° and less than or equal to 90°.

5. The display panel in claim 3, wherein a value range of the second angle is greater than or equal to 0° and less than or equal to 30°; alternatively,
the value range of the second angle is greater than or equal to 60° and less than or equal to 90°.

6. The display panel in claim 3, wherein the first angle is greater than the second angle, and the branch electrodes disposed in the first domain area are provided with the opening at a side parallel to the second trunk.

7. The display panel in claim 6, wherein the branch electrodes disposed in the second domain area are provided with the opening at a side parallel to the first trunk.

8. The display panel in claim 3, wherein the domain areas further comprise a third domain area and a fourth domain area, the third domain area is opposite to the first domain area, the fourth domain area is adjacent to the first domain area and the third domain area, each of the branch electrodes disposed in the third domain area has a third angle with the first trunk, and each of the branch electrodes disposed in the fourth domain area has a fourth angle with the first trunk.

9. The display panel in claim 8, wherein the third angle is equal to the first angle, and the fourth angle is equal to the second angle.

10. The display panel in claim 8, wherein the third angle is greater than the fourth angle, and the branch electrodes disposed in the third domain area are provided with the opening at a side parallel to the second trunk.

11. The display panel in claim 10, wherein the branch electrodes disposed in the fourth domain area are provided with the opening at a side parallel to the first trunk.

12. The display panel in claim 3, wherein the display panel is a liquid crystal display panel, and the display panel further comprises:
a first substrate, wherein the first electrode is disposed on a side of the first substrate;
a second substrate disposed opposite to the first substrate, wherein the second substrate maintains a first distance from the first substrate; and
liquid crystal molecules disposed between the first substrate and the second substrate, wherein a chiral reagent is doped in the liquid crystal molecules, and a pitch of the liquid crystal molecules is 2 to 15 times a value of the first distance.

13. The display panel in claim 12, wherein the first distance is greater than or equal to 2 μm and less than or equal to 4 μm.

14. The display panel in claim 12, wherein the liquid crystal molecules are negative liquid crystal molecules, and an optical path difference of the liquid crystal molecules is greater than or equal to 300 nm and less than or equal to 550 nm.

15. The display panel in claim 12, wherein the chiral reagent is a dextral chiral reagent, the first angle is greater than or equal to 60° and less than or equal to 90°, and the second angle is greater than or equal to 0° and less than or equal to 30°.

16. The display panel in claim 12, wherein the chiral reagent is a levorotatory chiral reagent, the first angle is greater than or equal to 0° and less than or equal to 30°, and the second angle is greater than or equal to 60° and less than or equal to 90′.

17. The display panel in claim 12, further comprising:
a first polarizer disposed on a side of the first substrate away from the second substrate; and
a second polarizer disposed on a side of the second substrate away from the first substrate;
wherein a polarizing axis of the first polarizer coincides with the first trunk, and a polarizing axis of the second polarizer coincides with the second trunk.

18. A display device, comprising a display panel, the display panel comprising:
a first electrode;
wherein an opening is defined at a side of the first electrode.

19. The display device in claim 18, wherein the first electrode comprises a main electrode and a plurality of branch electrodes, the main electrode defines a plurality of domain areas, the plurality of branch electrodes are disposed in the plurality of domain areas and electrically connect with the main electrode, and the branch electrodes in at least one of the domain areas are provided with the opening.

20. The display device in claim 19, wherein the main electrode comprises a first trunk and a second trunk, the first trunk and the second trunk are crossed, the domain areas comprise a first domain area and a second domain area adjacent to the first domain area, each of the branch electrodes disposed in the first domain area has a first angle with the first trunk, and each of the branch electrodes disposed in the second domain area has a second angle with the first trunk.
